(19) United States
(12) Patent Application Publication
(10) Pub. No.: US 2006/0048374 A1
(43) Pub. Date: Mar. 9, 2006

(54) Method and apparatus for attaching center hub

(75) Inventors: Akira Mizuta, Odawara-shi (JP); Hiroyuki Kitamura, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/216,150

(22) Filed: Sep. 1, 2005

(30) Foreign Application Priority Data
Sep. 3, 2004 (JP) 256793/2004

(51) Int. Cl. G11B 23/03

(52) U.S. Cl. 29/603.03; 360/133; 29/737

(57) ABSTRACT

In disk cartridge production, in order to enhance adhesion between a disk-shaped center hub provided with a center hole and a tacky ring formed of ring-shaped double sided adhesive tape material, when the tacky ring adhered on a base film is attached to a lower surface of the center hub before attaching the center hub to a central portion of a disk via the tacky ring, the base film is supported from the rear side by an elastic ring pad. The elastic ring pad has an outer diameter which is smaller than the outer diameter of the center hub but larger than the outer diameter of the tacky ring and an inner diameter which is larger than the inner diameter of the center hole of the center hub but smaller than the inner diameter of the tacky ring.

### BACKGROUND OF THE INVENTION

1. Field of the Invention

The present invention relates to equipment for manufacturing disk cartridges having a flat housing holding therein a rotary disk as an information recording medium, to which a disk-shaped center hub provided with a center hole is centrally affixed via a tacky ring formed of ring-shaped double sided adhesive tape material. More specifically, this invention relates to a method and apparatus for attaching such a center hub to the rotary disk.

2. Description of the Related Art

Conventionally, mobile equipment such as a digital camera, etc., uses a very small magnetic disk cartridge called “clik! (registered trademark)” as a recording medium (see, for example, U.S. Pat. No. 6,133,544).

FIG. 7A is a plan view and FIG. 7B is a bottom view showing a magnetic cartridge of the conventional magnetic disk cartridge, and FIG. 8 is an enlarged sectional view showing essential parts of the magnetic disk cartridge taken along line 8-8 in FIG. 7B.

This disk cartridge 1 comprises: a flat housing (width 50 mm, depth 55 mm, thickness 1.95 mm) which is constituted by a resin frame 2 (which is called a spacer or stabilizer) including a push portion 2a to be pushed with a finger when loading the disk cartridge to a drive device (not shown), and upper and lower shells 3 and 4 formed of a thin metal sheet of about 0.2 mm thick; and a 46.5 mm diameter magnetic disk 5 having a 40 MB storage capacity which is held in the flat housing such that it becomes rotatable when the disk cartridge 1 is mounted in the drive device. A center hub (center core) 10 having a center hole 10a is centrally affixed to the magnetic disk 5 via a tacky ring 15 which is formed of ring-shaped double sided adhesive tape material.

The magnetic disk cartridge 1 is designed to be loaded in a TYPE II PC card type drive device (width 53 mm, depth 85 mm, thickness 5 mm, not shown) by insertion of the cartridge 1 to a slot provided in the drive device. Each of the upper and lower shells 3, 4 has a wedge-shaped opening 6 formed to allow a recording/reproducing magnetic head of the disk drive to access the surface of the magnetic disk 5. A rotary shutter 7 having an opening 7a for pivotally opening and closing the opening 6 is held inside the upper and lower shells 3 and 4 with the rotary shutter 7 being urged towards its closing direction by means of a spring member (not shown).

The rotary shutter 7 is constituted by upper and lower shutter members 7U and 7D which are engaged with each other at the peripheries thereof. As is apparent from FIG. 8, the upper shutter member 7U is rotatably supported by a small-diameter cylinder 3a of the upper shell 3. The cylinder 3a projects inwardly from the lower surface of the upper shell 3. A retaining member 9 (called a center pin) is welded to the extremity of the cylinder 3a in order to prevent the upper shutter member 7U from falling off from the cylinder 3a such that the retaining member 9 is disposed within the center hole 10a of the center hub 10.

The lower shell 4 has a center hole 4a for exposing the center hub 10 towards the outside. A large diameter cylinder 7Da extending downwardly is provided at the central portion of the lower shutter member 7D and loosely engaged with the edge of the center hole 4a of the lower shell 4. The lower shell 4 rotatably supports the lower shutter member 7D via this large diameter cylinder 7Da. The distal end of the cylinder 7Da is caulked to form a flange 12. The flange 12 serves to prevent the lower shutter member 7D from falling off from the lower shell 4. A liner 13, which is for wiping off dirt and dust deposited on the magnetic disk 5 and constructed of, for example, a nonwoven fabric, is affixed to the inner surface of each of the upper and lower shutter members 7U and 7D.

As shown in FIG. 7B, an arcuate groove 4b concentric with the rotary shutter 7 is formed in the lower shell 4, while a shutter knob 7b which protrudes through the arcuate opening 4b and travels along this arcuate opening 4b to allow opening and closing of the rotary shutter 7 is affixed to the lower shutter member 7D. In association with loading of the magnetic disk cartridge 1 into the drive device, the shutter knob 7b engages with an engaging wall of the drive device and the rotary shutter 7 is in turn rotated to its open position where its opening 7a is aligned with the both openings 6 of the upper and lower shells 3 and 4, so that the magnetic disk 5 is exposed through the openings 6 of the upper and lower shells 3 and 4. On the other hand, when the magnetic disk cartridge 1 is unloaded from the drive device, the rotary shutter 7 is returned to its closed position shown in FIGS. 7A and 7B by means of a spring member (not shown).

Conventionally, a typical process for centrally attaching a center hub 10 to a magnetic disk 5 via a tacky ring 15 which has been produced by stamping a double sided adhesive tape into a ring shape comprises the steps of: feeding the tacky ring 15 to a first hub-attaching position with the tacky ring 15 being attached on the base film; loading one center hub 10 on a hub-attaching head; moving the hub-attaching head loaded with a center hub 10 to the first hub-attaching position; vertically lowering the center hub 10 onto the tacky ring 15 for attaching lower surface of the center hub 10 to the upper surface of the tacky ring 15; peeling off the base film from the tacky ring 15 which has been attached to both the upper surface of the base film and the lower surface of the center hub 10; and attaching at a second hub-attaching position the center hub 10 to a magnetic disk 5 via the tacky ring 15 which has been attached to the lower surface of the center hub 10.

Further, an elastic rubber pad is commonly provided at the first hub-attaching position for supporting the back side (the lower surface in this case) of the base film when the center hub 10 is attached onto the tacky ring 15.

However, when the center hub 10 is attached to the magnetic disk 5, wrinkles may occur on the tacky ring 15 and air may be entrapped between the center hub 10 and the magnetic disk 5, which could cause ripples on the tacky ring 15. This causes problems, such as adhesion between the center hub 10 and the tacky ring 15 being reduced, and the magnetic disk 5 wobbling during rotation.

### SUMMARY OF THE INVENTION

Conventionally, the elastic ring pad as mentioned above has a larger area than that of the bottom surface of the center hub 10. The present inventor noted that wrinkles occur on the tacky ring 15 depending on the size and shape of the elastic ring pad, and came to suggest the present invention from various experiments carried out by the inventor.

In accordance with one aspect of the invention, there is provided a center hub attaching method for attaching a disk-shaped center hub for a disk cartridge to a rotary disk as an information recording medium, the disk cartridge comprising the rotary disk and a flat housing in which the rotary disk is rotatably held, and the center with a center hole being coaxially attached to the rotary disk via a tacky ring formed of ring-shaped double sided adhesive tape material, the method comprising the steps of:

(1) providing and arranging a plurality of the tacky rings on a strip-like carrying base film;

(2) feeding the base film such that at least one of the tacky rings is positioned at a first hub-attaching position;

(3) positioning an elastic ring pad onto the first hub-attaching position, the elastic ring pad having an outer diameter which is smaller than the outer diameter of the center hub and larger than the outer diameter of the tacky ring and an inner diameter which is smaller than the outer diameter of the tacky ring and larger than the inner diameter of the center hole of the center;

(4) at the first hub-attaching position, temporarily attaching the center hub onto the base film via the tacky ring with the base film being supported by the elastic ring pad from the rear side;

(5) peeling off the base film from the tacky ring which has been attached to both the upper surface of the base film and the lower surface of the center hub; and

(6) thereafter, at a second hub-attaching position, permanently attaching the center hub onto the disk via the tacky ring which has been attached to the lower surface of the center hub.

The aforementioned elastic ring pad is preferably formed of a material, such as urethane rubber or silicone rubber, having a rubber hardness within the range of A50° to A80°.

Further, a speed to contact the center hub with the tacky ring at the first center-hub attaching position is preferably set 100 mm/s or less.

Further, at the first hub-attaching position, it is preferred to temporarily attach the center hub onto the base film via the tacky ring while vacuum-suctioning a region around the elastic pad. In this case, a region around the elastic pad is preferably vacuum-suctioned with a negative pressure of 45 kPa or less.

Further, after the center hub is temporarily attached on the base film via the tacky ring at the first center-hub attaching position, the base film is preferably peeled off from the tacky ring, which has been attached to both the upper surface of the base film and the lower surface of the center hub, by guiding the base film in a direction in which the base film is folded back.

In accordance with another aspect of the invention, there is provided a center hub attaching apparatus for attaching a disk-shaped center hub for a disk cartridge to a rotary disk as an information recording medium, the disk cartridge comprising the rotary disk and a flat housing in which the rotary disk is rotatably held, and the center with a center hole being coaxially attached to the rotary disk via a tacky ring formed of ring-shaped double sided adhesive tape material. The center hub attaching apparatus comprises an elastic ring pad for supporting the base film from the rear side during attachment of the center hub onto the tacky ring, which is disposed at a center hub attaching position to which the tacky ring is fed with the tacky ring being attached on the base film, wherein the elastic ring pad is constituted by an elastic member having an outer diameter which is smaller than the outer diameter of the center hub but larger than the outer diameter of the tacky ring and an inner diameter which is smaller than the outer diameter of the tacky ring but larger than the inner diameter of the center hole of the center hub.

The aforementioned elastic ring pad is preferably formed of a material, such as urethane rubber or silicone rubber, having a rubber hardness within the range of A50° to A80°.

Further, a speed to contact the center hub with the tacky ring at the first center-hub attaching position is preferably set 100 mm/s or less.

Besides, it is also preferred that a vacuum suction device for attracting a region around the elastic pad under suction with a negative pressure of 45 kPa or less is provided. According to the invention, the elastic ring pad is shaped and sized relative to the shape and size of the center hub and the tacky ring, and further the rubber hardness of the elastic ring pad is selected to fall within the range described above. Therefore, occurrence of wrinkles on the tacky ring during attaching the center hub onto the tacky ring can be effectively prevented and adhesion between the center hub 10 and the tacky ring 15 can be enhanced, as a result of which the wobbling during rotation of the magnetic disk to which the center hub has been attached via the tacky ring 15 can be suppressed.

Further, a device for vacuum-suctioning the region around the elastic ring pad is provided, which prevents air entrapment between the tacky ring and the center hub.

### BRIEF DESCRIPTION OF THE DRAWINGS

FIG. 1 is a schematic front view of a center hub attaching apparatus of the invention;

FIGS. 2A to 2E are illustrative diagrams showing step by step a procedure for producing a carrying base film having thereon tacky rings used by the center hub attaching apparatus shown in FIG. 1;

FIG. 3 is a schematic plan view of the center hub attaching apparatus shown in FIG. 1;

FIG. 4 is a schematic side view of the center hub attaching apparatus shown in FIG. 1;

FIG. 5 is a diagrammatic cross-sectional view showing a guide member and a first hub attaching section of the center hub attaching apparatus shown in FIG. 1;

FIG. 6 is a schematic enlarged cross-sectional view showing the first hub attaching section shown in FIG. 5;

FIGS. 7A is a plan view and FIG. 7B is a bottom view, showing a disk cartridge; and

FIG. 8 is an enlarged cross-sectional view taken along line 8-8 in FIG. 7B.

### DESCRIPTION OF THE PREFERRED EMBODIMENTS

Embodiments of the present invention will hereinafter be described in detail with reference to the drawings.

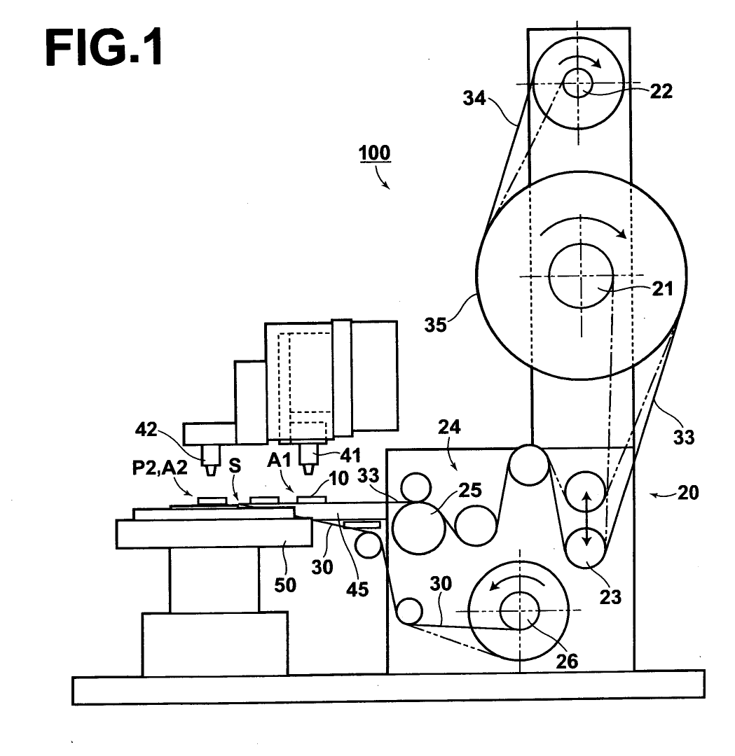

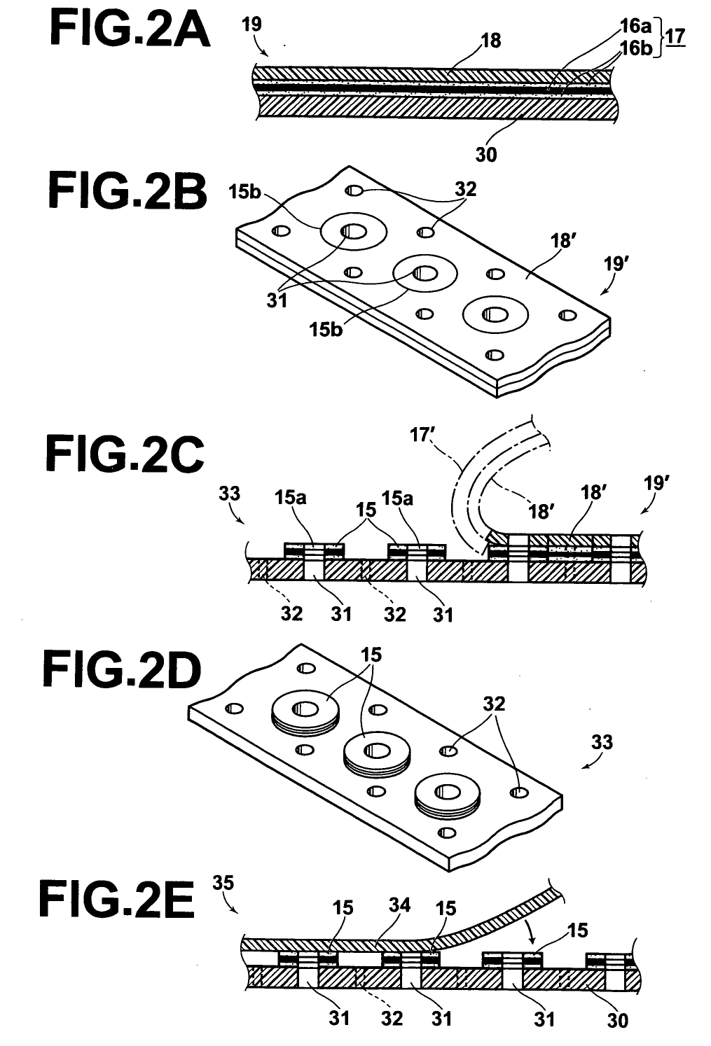

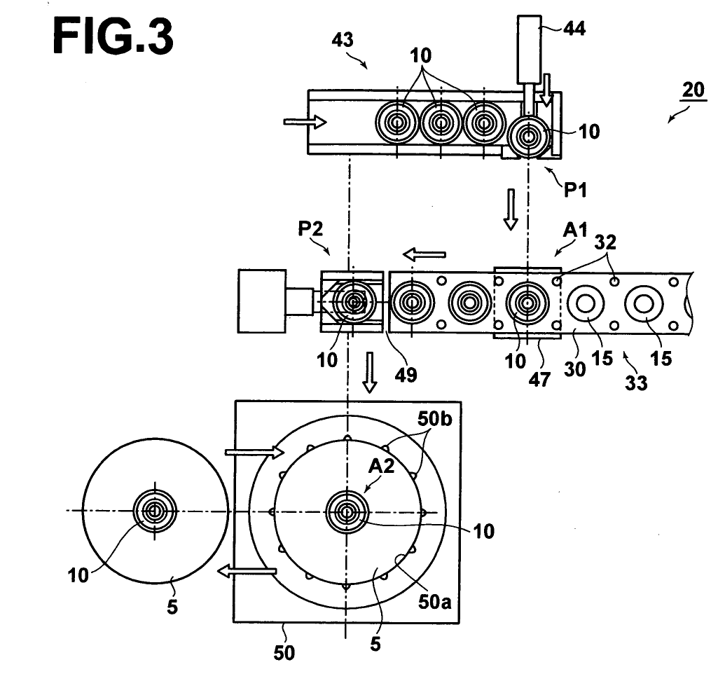

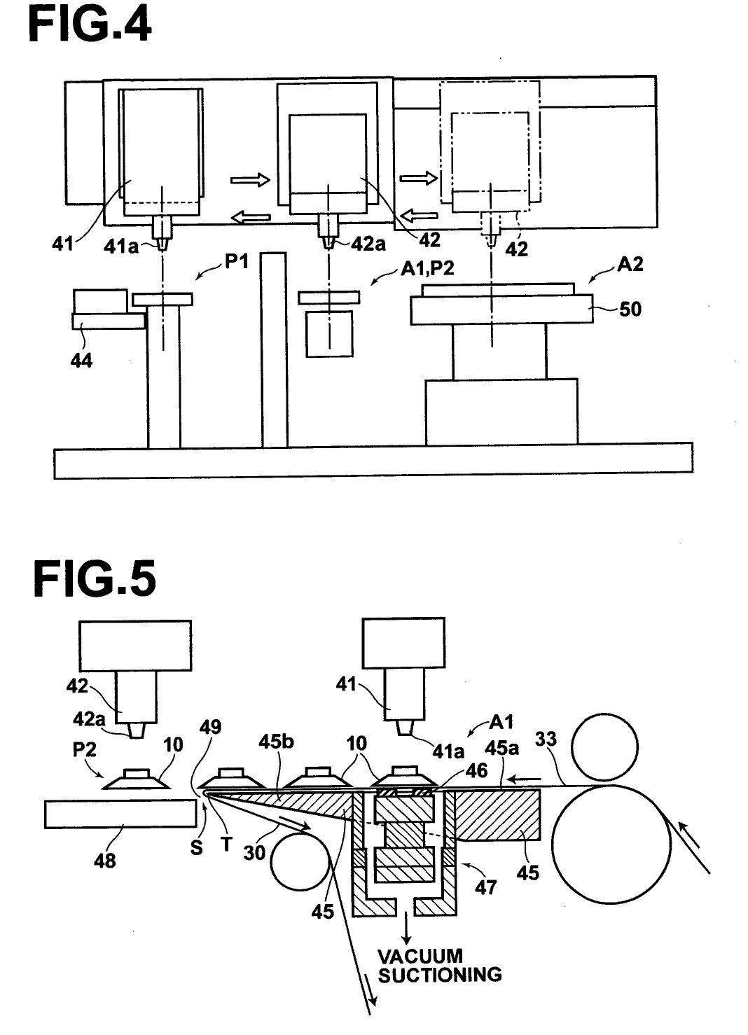

FIG. 1 is a schematic front view of a center hub attaching apparatus of the invention, FIGS. 2A to 2E are illustrative diagrams showing step by step a procedure for producing a carrying base film having thereon tacky rings used by the center hub attaching apparatus shown in FIG. 1, FIG. 3 is a schematic plan view showing an essential part of the center hub attaching apparatus in FIG. 1; and FIG. 4 is the side view thereof.

First, how to produce tacky rings, and details of a strip-like base film for carrying the tacky rings will be described with reference to FIGS. 2A to 2E.

First, a double sided adhesive tape 19 as shown in an enlarged cross-sectional view of FIG. 2A is provided. Similar to conventional double sided adhesive tapes, the aforementioned double sided adhesive tape 19 comprises a base film 30, a release liner 18, and a double sided adhesive film 17 disposed therebetween. The double sided adhesive film 17 is constituted by a substrate film 16a and adhesive layers 16b and 16b which have been applied to opposite surfaces of the substrate film 16a.

As shown in a perspective view of FIG. 2B, circular holes 31 having substantially the same size as a center hole 15a of a tacky ring 15 and perforations 32 are then formed in the base film 30 as through holes extending through both the double sided adhesive tape 19 and the release liner 18 such that the circular holes 31 and the perforations 32 are respectively evenly spaced along the longitudinal direction of the base film 30. Further, a half-cut is provided in the base film 30 concentrically around each circular hole 31 such that the half-cut circumferentially extends along a circle having a diameter 15b same as the outer diameter of the tacky ring 15. Thus, a perforated double sided adhesive tape 19′ having thereon a perforated release liner 18′ is provided.

After that, a release-liner-laminated base film 35 is formed by: removing unnecessary double sided adhesive film 17′ together with a perforated release liner 1′ from the surface of the base film 30 as shown in an enlarged cross-sectional view of FIG. 2C; providing a tacky-ring-carrying base film 33 having tacky rings 15 arranged in series on the surface of the base film 30 as shown in FIG. 2D; and applying to the tacky-ring-carrying base film 33 a release liner 34 intended for preventing the tacky rings 15 from being adhered to the tacky-ring-carrying film 33 disposed adjoining the tacky rings 15 when the tacky-ring-carrying film 33 is wound around a base film supply spool 21 (see FIG. 1) as shown in FIG. 2E.

The release-liner-laminated base film 35 is wound around the base film supply spool 21 incorporated in a base film supply/take-up mechanism 20 illustrated on the right-hand side of a center hub attaching apparatus 100 in FIG. 1. During feeding, the release liner 34 is in a form of the tacky-ring-attached base film 33 as shown in FIG. 2C and threaded through a roller group 24 including a dancer roller 23 and fed toward a first hub-attaching position A1 by means of a sprocket 25 while winding up the release liner by the take-up spool 23, so that the tacky rings 15 are conveyed one by one to the first hub-attaching position A1. Each roller of the roller group 24 has a guide formed at each outer peripheral edge thereof such that the tacky rings 15 do not touch the roller surface.

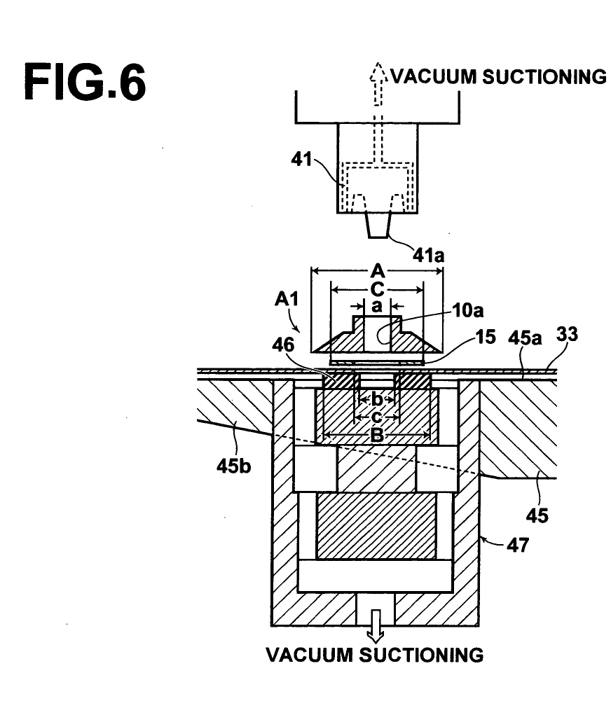

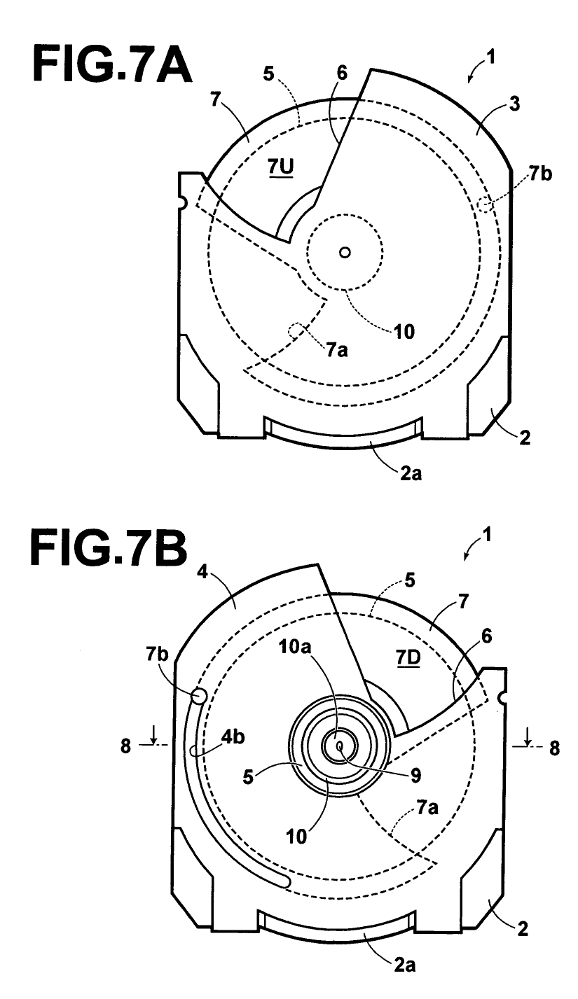

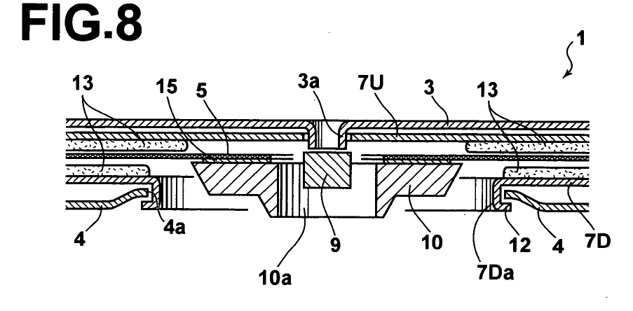

This center hub attaching apparatus 100 comprises, as shown in FIG. 4 and FIG. 6, a first vacuum-suction hub-attaching head 41 having a positioning pin 41a and a second vacuum-suction hub-attaching head 42 having a positioning pin 42a. Each positioning pin 41a, 42a is to be inserted into a center hole 10a of a center hub 10.

The first hub-attaching head 41 is provided in a manner so as to be reciprocally movable between a first hub-standby position P1 in a hub supply section 43 shown in an upper part of FIG. 3 and the aforementioned first hub-attaching position A1. More specifically, the first hub-attaching head 41 serves to pick up one of the center hubs 10 at the first hub-standby position P1; feed the center hub 10 to the first hub-attaching position A1; and attach the center hub 10 to a tacky-ring-attached base film 33 via a tacky ring 15 attached on the base film 30. As a result, the tacky ring 15 on the base film 30 is attached to both the upper surface of the base film 30 and the lower surface of the center hub 10.

The aforementioned hub supply section 43 comprises a positioning member 44 for positioning one center hub 10 at a time to the first hub-standby position P1.

The second hub-attaching head 42 is provided in a manner so as to be reciprocally movable between a second hub-standby position P2 in a hub supply section 43 described later and the second hub-attaching position A2. After the base film 30 is peeled off at a base film peel-off position S from the tacky ring which has been attached to both the upper surface of the base film 30 and the lower surface of the center hub 10, the second hub-attaching head 42 serves to pick up the center hub 10 which is attached with a tacky ring 15 and is to be positioned to a second hub-attaching position A2; feed the center hub to the second hub-attaching position A2; and attach the center hub 10 to the central portion of a magnetic disk 5 via the tacky ring 15.

Referring to FIG. 5, a guide member 45 having an upper surface 45a for guiding the tacky-ring-attached base film 33 to the first hub-attaching position A1 and then to the base film peel-off position S is disposed at the first hub-attaching position A1. The guide member 45 also has a wedge portion 45b disposed downstream along the traveling direction of the tacky-ring-attached base film 33. The apex T of the wedge portion 45b is located at the base film peel-off position S where the base film 30 is peeled off as described later. The apex T of the wedge portion 45b rounded slightly such that the base film 30 is not cut.

Further, at the first hub-attaching position A1, a support table 47 having thereon an elastic ring pad 46 for receiving the lower surface of the base film 33 is secured, as shown in FIG. 6, to the guide member 45.

The aforementioned elastic ring pad 46 is made of a material, such as urethane rubber or silicone rubber, having a rubber hardness within the range of A45° to A80°, and formed to have an outer diameter B (about 13 mm) which is smaller than the outer diameter A (about 15 mm) of the center hub 10 and larger than the outer diameter C (about 11 mm) of the tacky ring 15. Further, the elastic ring pad 46 has an inner diameter b which is larger than the inner diameter a of the center hole 10a of the center hub 10 and smaller than the inner diameter c of the center hole 15a of the tacky ring 15. Further, there is provided a vacuum suction device for attracting a region around the elastic pad 46 under suction with a negative pressure of −50 KPa or less when the center hub 10 is attached. Further, a speed to contact the center hub 10 with the tacky ring 15 is preferably set 100 mm/s or less.

For the sake of clarity, the tacky-ring-attached base film 33 and the center hub 10 are shown as if they are suspended above the upper surface 45a of the guide member 45 in FIGS. 5 and 6 and the tacky ring 15 is shown as if the tacky ring 15 is separated from the tacky-ring-attached base film 33 and the center hub 10, whereas in reality, the tacky-ring-attached base film 33 and the center hub 10 are in contact with the upper surface 45a and that the tacky ring 15 is in contact with the tacky-ring-attached base film 33 and the center hub 10.

As described above, after the center hub 10 is attached to the tacky-ring-attached base film 33 via the tacky ring 15 at the first hub-attaching position A1, that is, after the tacky ring 15 is attached to both the upper surface of the base film 30 and the lower surface of the center hub 10, and moved to the base film peel-off position S which is spaced downstream from the first hub-attaching position A1 along the tacky-ring-attached base film 33 traveling direction as shown in FIG. 5, the base film 30 is fed downward firstly through a gap 49 between the apex T of the wedge portion 45b and a center hub support table 48 adjacent thereto, and then, is folded back about the apex T of the wedge portion 45b and guided in a direction opposite to the tacky-ring-attached base film 33 traveling direction. As a result, the base film 30 is caused to be peeled off from the tacky ring 15 which has been attached to both the upper surface of the base film 30 and the lower surface of the center hub 10, and the center hub 10 having the tacky ring 15 on the lower surface thereof is then transferred onto the center hub support table 48 and positioned to the second hub-standby position P2.

In this case, since the base film peel-off position S is set at a position spaced downstream from the first hub-attaching position A1 along the tacky-ring-attached base film 33 traveling direction as described above, a certain short time (at least 3 seconds) is elapsed from the attachment of the tacky ring 15 onto the lower surface of the center hub 10 to the peel-off of the base film 30.

The base film 30 which has been peeled from the tacky ring 15 in the manner as described above is wound on the base film take-up spool 26 as shown in FIG. 1.

On the other hand, the second hub-attaching head 42 attracts the tacky-ring-attached center hub 10 positioned at the second hub-standby position P2, transports the attracted tacky-ring-attached center hub 10 to the second hub-attaching position A2, and attaches the center hub 10 to the central portion of the magnetic disk 5 via the tacky ring 15 which has been attached on the lower surface of the center hub 10.

A disk support table 50 including a recess 50a for receiving the magnetic disk 5 is provided at the second hub-attaching position A2, where a magnetic disk 5 is attached thereon with the center hub 10 and then the magnetic disk with the center hub 10 is removed to the exterior by a disk take-out head having a similar configuration to that of the first and second hub-attaching heads 41 and 42.

In order to prevent the magnetic disk 5 from being attached to the bottom surface of the recess 50a by negative pressure when the magnetic disk 5 is being removed from the recess 50a, a plurality of vent passageways 50b which communicate with the recess 50a are provided around the recess 50a.

A specific embodiment of a center hub attaching apparatus in accordance with the present invention has been described for the purpose illustrating the configuration and operations thereof. According to the embodiment, the shape and size of the elastic ring pad 46, which is positioned at the first hub-attaching position A1 and serves to support the base film 33 from underneath, are set in relation to the shape and size of the center hub 10 and tacky ring 15, and further, the rubber hardness of the elastic ring pad 46 is selected to fall within the aforementioned range. As a result, wrinkle occurrence on the tacky ring 15 when the center hub 10 is attached to the magnetic disk 5 can be efficiently prevented.

Accordingly, adhesion between the center hub 10 and the tacky ring 15 can be enhanced, as a result of which the wobbling during rotation of the magnetic disk 5 to which the center hub 10 has been attached via the tacky ring 15 can be suppressed.

Further, a device for vacuum-suctioning the region around the elastic ring pad 46 is provided, which allows air from being entrapped between the tacky ring 15 and the center hub 10.

Still further, according the embodiment of the invention, the base film 30 is guided in a direction in which the base film 30 is folded back about the apex T of the wedge portion 45b of the guide member 45 such that the base film 30 is caused to be peeled off from the tacky ring 15 which has been attached to both the upper surface of the base film 30 and the lower surface of the center hub 10. Therefore, the base film 30 is gradually peeled off from the front edge of the tacky ring 15, which ensures a stable peeling. Therefore, this also contributes to solve the problems of wrinkle occurrence on the tacky ring 15 and air entrapment between the center hub 10 and the magnetic disk 5 when the center hub 10 is attached to the magnetic disk 5 can be solved.

In addition, according to the embodiment of the invention, the base film 30 is peeled off after a lapse of a predetermined time period from attachment of the center hub 10 on the base film 30 at the first hub-attaching position A1, and therefore the tacky ring 15 is more securely attached to the lower surface of the center hub 10. Accordingly, an effect of further stabilizing the attached state of the center hub 10 with respect to the magnetic disk 5 is produced.

Further, the apex T of the wedge portion 45b of the guide member 45 provided at the base film peel-off position S is located at a position spaced downstream from the first hub-attaching position A1 along the tacky-ring-attached base film 33 traveling direction, and therefore a certain time period is elapsed during movement of the tacky-ring-attached base film 33 from the first hub-attaching position A1 to the apex T of the wedge portion 45b. This makes it possible to produce the aforementioned effect.

While the present invention was described using a “clik! (registered trademark)” for exemplary purposes, it must be appreciated that the invention is not limited thereto but applicable to any other flexible magnetic disks.

What is claimed is:

1. A center hub attaching method for attaching a disk-shaped center hub for a disk cartridge to a rotary disk as an information recording medium, the disk cartridge comprising the rotary disk and a flat housing in which the rotary disk is rotatably held, and the center with a center hole being coaxially attached to the rotary disk via a tacky ring formed of ring-shaped double sided adhesive tape material, the method comprising the steps of:
(1) providing and arranging a plurality of the tacky rings on a strip-like carrying base film;
(2) feeding the base film such that at least one of the tacky rings is positioned at a first hub-attaching position;
(3) positioning an elastic ring pad onto the first hub-attaching position, the elastic ring pad having an outer diameter which is smaller than the outer diameter of the center hub and larger than the outer diameter of the tacky ring and an inner diameter which is smaller than the outer diameter of the tacky ring and larger than the inner diameter of the center hole of the center;
(4) at the first hub-attaching position, temporarily attaching the center hub onto the base film via the tacky ring with the base film being supported by the elastic ring pad from the rear side;
(5) peeling off the base film from the tacky ring which has been attached to both the upper surface of the base film and the lower surface of the center hub; and
(6) thereafter, at a second hub-attaching position, permanently attaching the center hub onto the disk via the tacky ring which has been attached to the lower surface of the center hub.

2. The method as set forth in claim 1, wherein the elastic ring pad is constituted by an elastic material having a rubber hardness within a range of A50° to A80°.

3. The method as set forth in claim 2, wherein the elastic ring pad is formed of urethane rubber.

4. The method as set forth in claim 2, wherein the elastic ring pad is formed of silicone rubber.

5. The method as set forth in claim 1, wherein a speed to contact the center hub with the tacky ring at the first center-hub attaching position is set 100 mm/s or less.

6. The method as set forth in claim 1, wherein at the first hub-attaching position, the center hub is temporarily attached onto the base film via the tacky ring with a region around the elastic pad being subjected to vacuum suction.

7. The method as set forth in claim 6, wherein the region around the elastic ring pad is vacuum-suctioned with a negative pressure of 45 kPa or less.

8. The method as set forth in claim 1, wherein after the center hub is temporarily attached on the base film via the tacky ring at the first center-hub attaching position, the base film is peeled off from the tacky ring, which has been attached to both the upper surface of the base film and the lower surface of the center hub, by guiding the base film in a direction in which the base film is folded back.

9. A center hub attaching apparatus for attaching a disk-shaped center hub for a disk cartridge to a rotary disk as an information recording medium, the disk cartridge comprising the rotary disk and a flat housing in which the rotary disk is rotatably held, and the center with a center hole being coaxially attached to the rotary disk via a tacky ring formed of ring-shaped double sided adhesive tape material,
comprising an elastic ring pad for supporting the base film from the rear side during attachment of the center hub onto the tacky ring, which is disposed at a center hub attaching position to which the tacky ring is fed with the tacky ring being attached on the base film, wherein the elastic ring pad is constituted by an elastic member having an outer diameter which is smaller than the outer diameter of the center hub and larger than the outer diameter of the tacky ring and an inner diameter which is smaller than the outer diameter of the tacky ring and larger than the inner diameter of the center hole of the center hub.

10. The apparatus as set forth in claim 9, wherein the elastic ring pad is constituted by an elastic member having a rubber hardness within a range of A50° to A80°.

11. The apparatus as set forth in claim 10, wherein the elastic ring pad is formed of urethane rubber.

12. The apparatus as set forth in claim 10, wherein the elastic ring pad is formed of silicone rubber.

13. The apparatus as set forth in claim 9, wherein a speed to contact the center hub with the tacky ring at the first center-hub attaching position is set 100 mm/s or less.

14. The apparatus as set forth in claim 9, further comprising means for vacuum-suctioning a region around the elastic ring pad.

15. The apparatus as set forth in claim 14, further comprising means for vacuum-suctioning a region around the elastic ring pad with a negative pressure of 45 kPa or less.
